(19) United States
(12) Patent Application Publication
(10) Pub. No.: US 2018/0349911 A1
(43) Pub. Date: Dec. 6, 2018

(54) PAYMENT METHOD AND DEVICE USING SAID METHOD

(71) Applicant: GEMALTO SA, Meudon (FR)

(72) Inventor: François LAMAIRE, Meudon (FR)

(21) Appl. No.: 15/780,184

(22) PCT Filed: Nov. 28, 2016
(86) PCT No.: PCT/EP2016/078991

§ 371 Date: May 30, 2018

(30) Foreign Application Priority Data
Nov. 30, 2015 (EP) 15306896.0

(51) Int. Cl. G06Q 20/40; G06Q 20/22; G06Q 20/32

(52) U.S. Cl. CPC G06Q 20/40145; G06Q 20/3278; G06Q 20/227

(57) ABSTRACT

The invention relates to a payment method using an electronic device (200) provided with a biometric sensor (220), a communication interface for communicating with a payment terminal, and a processing unit (230) provided with banking information, reference biometric information, an authentication application and one or more payment applications. The bank information and the payment applications offer the user at least two payment means (610, 620, 630).

The method allows a selection of the payment means (610, 620, 630) by associating with each payment means a biometric identifier (640, 650, 660) which is specific to same, so that the biometric authentication makes it possible to select the payment means and to generate a transaction authorization cryptogram with said payment means.

The invention relates to a payment method and to a device that implements said method.

Among the various payment means, electronic payment means, such as smart cards, mobile telephones or other equivalent objects, are one group thereof. These payment means are able to interact with a reader with or without contact or with a remote server in order to make a payment. A payment is understood to mean any authentication and/or authorization linked to a transaction involving a payment, debit of a credit unit (in particular for a transport application), the mere authentication of a person who then triggers a subsequent payment or who is validating a prepayment that has already been made.

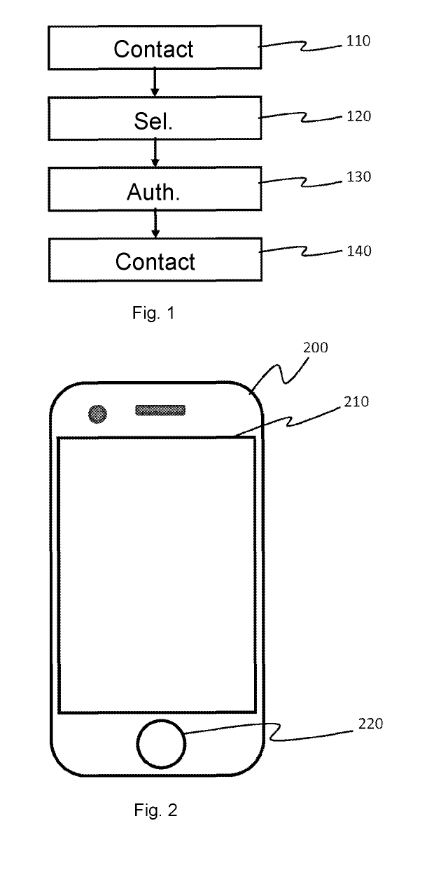

By way of current example, one means for making a payment using a mobile telephone is indicated in FIG. 1. A first step 110 consists in bringing the mobile telephone and the reader in contact with one another (or tapping said telephone). Following this step, the reader transfers a selection request to the mobile telephone, which launches a selection application on the telephone. It is then that the selection application gives the user the choice of validating the payment using a payment means proposed by default or selecting another payment means in step 120. This step 120 therefore makes it possible to select the payment means comprising a payment source, such as an account, a card or a payment type (prepaid, debit or credit). Once the selection has been made, the payment application associated with the selected payment means requests that the user authenticate, step 130. This step 130 may be carried out in various ways, e.g. by entering a PIN code, presenting a fingerprint, detecting a face, or the like. Once the authentication step 130 has been carried out, it is then possible to finalize the transaction, for example by bringing the telephone and the reader in contact with one another a second time, in step 140. In step 140, the telephone transmits the banking information for carrying out the transaction, which information is accompanied by a payment authorization request signature. More generally, this is referred to as a transaction authorization cryptogram, widely referred to as an ARQC (authorization request cryptogram) according to the EMV payment standard.

In order to simplify the payment procedure, it is a known practice to dispense with the first step 110. In this case, the user directly carries out the step 120 of selecting the payment means. Step 130 authenticates the holder and the transaction request is generated in step 140. A method of this kind, while quicker, makes it necessary to put a certain level of trust in the reader because the amount is no longer displayed on the screen of the telephone during authentication, only on the reader.

The current trend is to speed up checkouts and in particular reduce the time required for payment. To this end, it is being sought to move towards the simplest possible use for the user while ensuring maximum security. The use of biometrics is an effective means for authenticating a user while ensuring a high degree of simplicity of use for the user.

The invention proposes a novel method for making payments even more quickly. More particularly, the invention is a method for payment by means of an electronic device having at least one biometric sensor, at least one communication interface for communicating with an external or remote terminal, and at least one processing unit having banking information, biometric reference information, at least one authentication software program, one or more payment software programs, with the banking information and the payment software programs providing the user with at least two payment means. The method allows a selection of the payment means by associating each payment means with a biometric identifier that is specific to said payment means, such that the biometric authentication makes it possible both to select the payment means and to generate a cryptogram for authorizing a transaction by means of said payment means.

A step carried by the user is thus dispensed with, without reducing the level of level of the payment authorization.

In various embodiments, the selection of the payment means consists in carrying out at least one of a plurality of selection options. The selection may be made from among banking information that corresponds to one of at least two bank cards or corresponds to one of at least two bank accounts. The selection may be made from among at least two payment types (prepaid, immediate debit, deferred debit, credit). The selection may be made from among at least two separate payment software programs.

In one embodiment, prior to the selection of the payment means, a payment request is received by the electronic device together with an amount to be paid and in which device the amount to be paid is indicated on the display device along with a selection and authentication request.

Preferably, the biometric identifiers are fingerprints and one fingerprint can only be used for one payment means. The fingerprint to be presented for each payment means may be indicated on the display device.

In another aspect, the invention is an electronic device comprising at least one biometric sensor, at least one communication interface for communicating with an external or remote terminal, and at least one processing unit having banking information, biometric reference information, at least one authentication software program, one or more payment software programs, with the banking information and the payment software programs providing the user with at least two payment means. Each payment means is associated with a biometric identifier that is specific to said payment means, and the authentication software program allows a selection of the payment means at the same time as the biometric authentication by associating the payment means with the presented biometric print after being authenticated.

Preferably, the communication interface may be a radio interface that is compatible with a contactless payment terminal. The communication interface may be an internet interface. The biometric sensor may be a fingerprint sensor, each fingerprint being associated with one payment means. The processing unit may comprise a secure processing circuit that is resistant to attacks, so that at least part of the authentication and the generation of a transaction authorization cryptogram is carried out in said secure processing circuit. The electronic device may further comprise a display device for displaying a transaction amount and a choice of payment means.

The invention will be better understood on reading the following description, which refers to the following figures, in which:

FIG. 1 is a flowchart for electronic payment according to the invention,

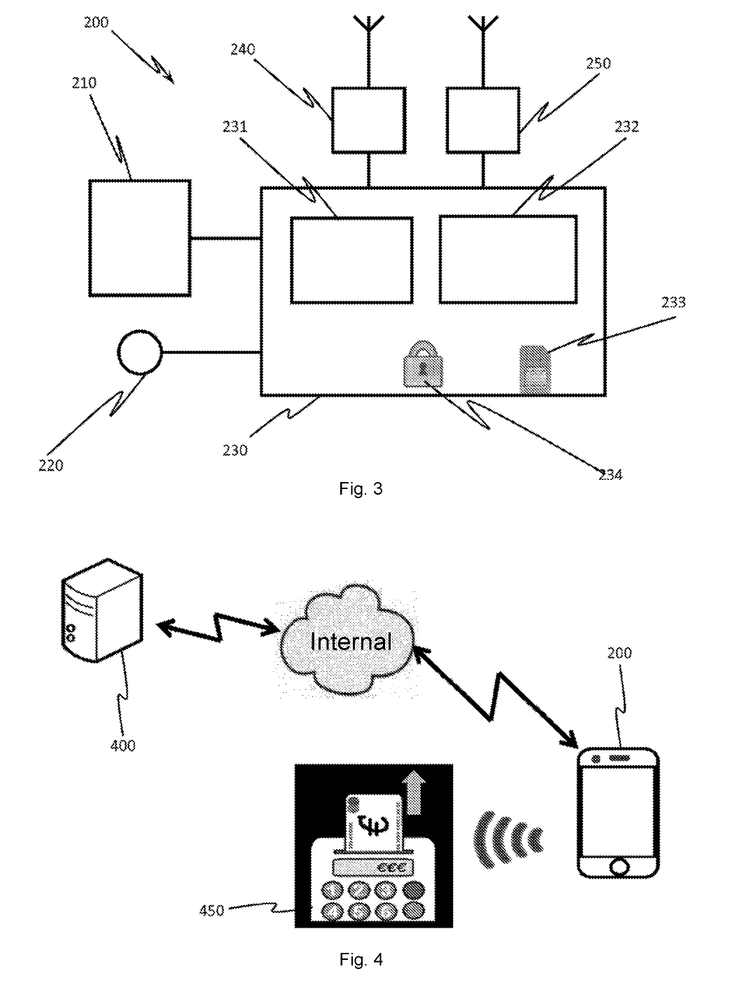

FIGS. 2 and 3 show a mobile telephone that can implement the invention, FIG. 4 shows a mobile telephone in a payment system, and

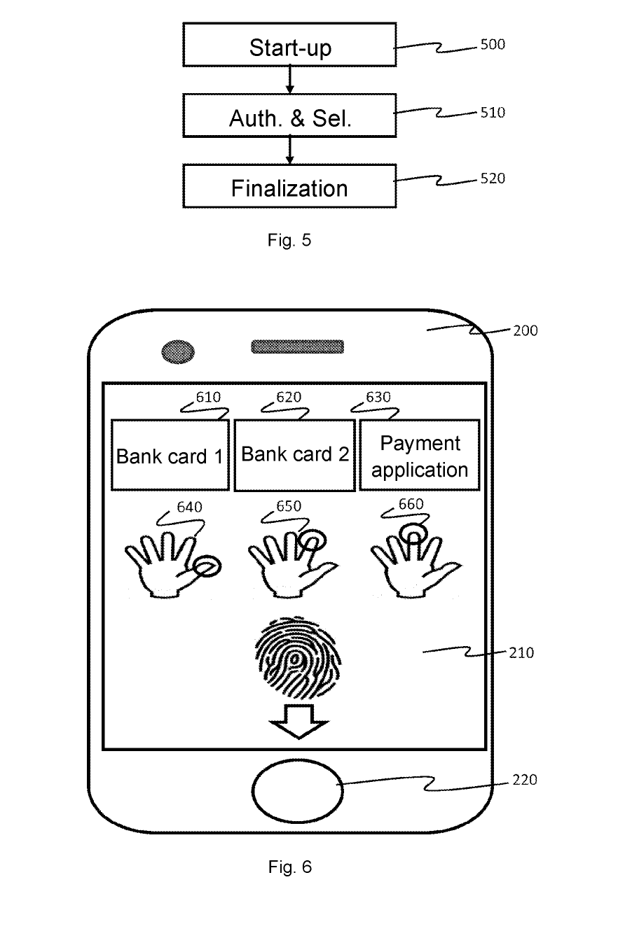

FIGS. 5 to 7 show the method according to the invention.

FIGS. 2 and 3 show a mobile telephone 200 provided with a touch screen 210 and a fingerprint sensor 220 that is connected to a processing unit 230. The telephone 200 further comprises a first interface 240 for communicating with a mobile radio telecommunications network and a second radio interface 250 for proximity communication.

The processing unit 230 comprises a microprocessor 231 and a memory 232 comprising a volatile portion and a non-volatile portion. The memory 232 comprises most of the programs and data that run on the phone. The processing unit 230 further comprises a SIM card 233 and a secure circuit 234. The SIM card 233 comprises information necessary for identifying the telephone on the radio-telephony network and also programs and data which may require a certain level of security, e.g. for a payment. The secure circuit 234 is typically a microcontroller that is resistant to attacks; this type of circuit is more commonly known as a “secure element” and is intended to retain all the highly confidential information in the processing unit and further comprises sensitive programs linked to this data. The fingerprint authentication program for verifying that the print presented to the sensor 220 actually corresponds to a known print is located in said secure circuit 234. The sensitive portion of a payment software program that is specific to the telephone may also be located in this secure element 234.

The first communication interface 240 is a radio-telephony interface that is compatible with the standards allowing the transfer of data that authorizes communication via the internet. The second communication interface 250 is a proximity interface, which may be of different types. It is known to use, as a proximity interface, interfaces linked to Bluetooth-based or Wi-Fi-based data exchange for exchanging any type of data. It is also known to use an NFC (near-field communication) interface that is compatible with contactless payment terminals according to the ISO 14443 standard.

As is known to a person skilled in the art, a telephone 200 may comprise one or more payment applications, some of which may be executed either on the secure circuit 234 or on the SIM card 233 if it is desired to have a minimum level of banking data security. The applications executed on the secure circuit 234 or the SIM card 233 are generally launched by a program executed by the microprocessor 231, which sends a suitable command to said secure circuit 234 or SIM card 233 each time that said program is set to perform a sensitive operation.

By way of example, when a program being processed requests to verify a fingerprint, a print is captured by means of the fingerprint sensor 220, this being controlled by a program being executed on the microprocessor 231. The microprocessor 231 then creates a print verification command directed at the secure circuit 234, which receives the captured print or a signature of said print. Upon receiving this command, the secure circuit 234 compares this captured print with one or more reference prints. If a reference print matches the captured print, the secure circuit 234 returns a positive authentication response. If a plurality of prints are stored, the secure circuit may also return an identifier corresponding to the authenticated print. The fingerprint authentication command may also contain the information relating to the transaction; in this way, the message in response to the authentication command may also contain the information necessary for the transaction, including a signature of the transaction and/or an encrypted message corresponding to a transaction authorization cryptogram for validating the transaction on the server of a bank.

FIG. 4 shows two types of payment environment that the telephone 200 may encounter. A first mode of payment is payment via the internet, in which the telephone 200 communicates via a merchant site 400 to which said telephone is connected via the internet and the radiotelephony network. A second mode of payment is in-store payment using a bank payment terminal 450 that communicates with the telephone via close-range radio communication.

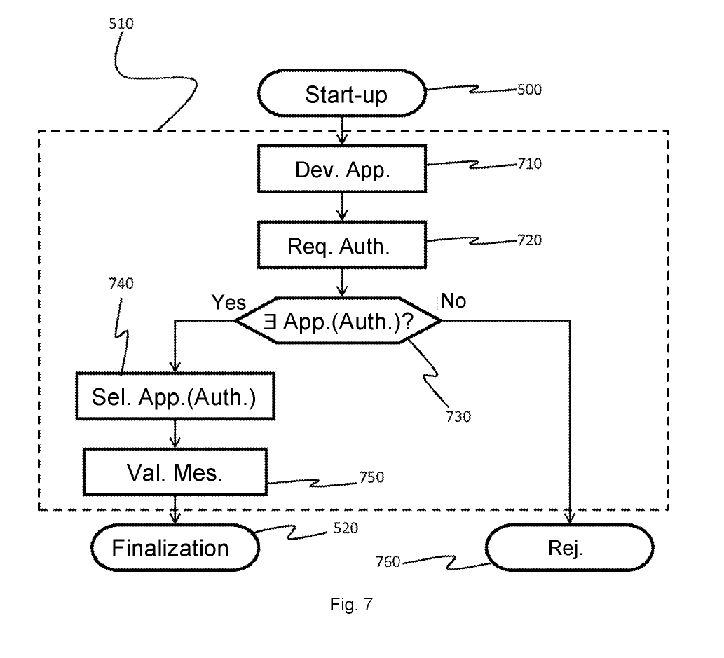

FIGS. 5 to 7 show the functioning of the invention in the context of a payment made at a payment terminal 450. FIG. 5 shows the steps carried out by the user. FIG. 6 gives an example of the user interface that may be used. FIG. 7 shows what happens, functionally speaking, in the telephone.

As indicated in FIG. 5, a user wishing to make a purchase “taps” their telephone 200 on the payment terminal 450 in a start-up step 500. In this start-up step, the payment terminal 450 sends a payment authorization request to the telephone. The request received by the telephone automatically launches a selection application that requests the user to validate the payment in an authentication and payment mode selection step 510. In this step 510, the screen 210 displays the screen shown in FIG. 6, which requests the user to validate the transaction by means of the print sensor 220. It is optionally possible to also display the amount of the transaction for which payment authorization is requested. However, the validation screen proposes various modes of payment 610 to 630 while indicating a finger 640 to 660 associated with each mode of payment 610 to 630. When the user authenticates by using one of the indicated fingers, said user simultaneously selects the mode of payment associated with the print of said finger. Since the authentication and selection of the payment means are simultaneous, all the user has to do is “tap” their telephone 200 on the payment terminal 450 once again, which makes it possible to complete the transaction by providing the payment terminal with a transaction authentication cryptogram, which comprises, for example, the identifier of the transaction, account or card to be debited and a signature for this information for validating the debit authorization.

A person skilled in the art will note that a payment means is understood to mean an assembly comprising both a payment software program and banking information in the form of a bank card identifier or identifiers for accounts to be debited. By way of illustration, the modes of payment 610 and 620 may correspond to a single software program for payment by means of bank card emulation, while the mode of payment 630 corresponds to a software program for payment by means of an electronic coupon that is provided by a shop chain and can only be used in said shop chain.

A person skilled in the art may also note that, in FIG. 6, the fingers are clearly identified in a drawing of the hand. For further security, this type of display may be replaced by statements such as “1^{st} finger, “2^{nd} finger”, etc., only the user knowing which the actual corresponding finger is.

In terms of the software, reference should be made to FIG. 7, which shows step 510 being carried out. Following the reception of a payment validation request, a first step 710 launches a selection application that displays the various payment means, as is indicated in FIG. 6. The display may optionally also indicate the amount of the transaction to be completed. A second step 720 then requests the user to validate the payment by authenticating means of the biometric sensor 220. The screen in FIG. 6 is displayed until a print capture is received by the sensor 220.

The user passes a finger over the biometric sensor 220, and a verification 730 makes it possible to verify whether the print presented to the biometric sensor corresponds to a stored print and the print is associated with a payment means. If a payment means corresponds to the print, a selection step 740 launches the application on the basis of parameters corresponding to the payment means associated with the print while preserving the authentication carried out. In this way, once the selection has been made, the payment application can proceed directly to the validation step 750 in order to create a transaction authorization cryptogram that corresponds to the payment means that has just been selected.

Following the validation step 750, all the user has to do is “tap” the telephone again on the reader to transmit the transaction authorization cryptogram to the payment terminal 450.

During verification, if no mode of payment is associated with the print or if the print does not correspond to a previously stored print, the payment operation is rejected 760 and a message indicates the rejection to the user and ends the selection application without triggering a payment application.

As a person skilled in the art will realize, other algorithms may be implemented by mixing the order of the steps. This may be the case if the print is authenticated in each payment application and not in the selection application. The verification may alternatively be carried out by successively supplying the print to various payment applications, and the selection will be made automatically as soon as one of the payment applications recognizes the presented print. What is important is that the user sees only a single authentication step that is also used to select the mode of payment. It goes without saying that the embodiment indicated here is just one of a wide range of means for implementation.

Furthermore, reference is made in this case to a two-tap payment operation. A person skilled in the art may also realize that the first tap may be replaced by an action performed by the user. In this case, the validation step 750 is carried out at the same time as the finalization step 520. Upon the tap 520, the reader sends a selection command for completing an identified transaction. The step 750 may then take place by generating the transaction authorization cryptogram on the basis of the authentication that was previously carried out and the identification of the transaction received in the selection command. Once the cryptogram has been produced, it is automatically sent back to the payment terminal.

In the case of a payment operation performed via the internet, steps 500 and 520 are replaced by interactions with a remote server or a script sent by a remote server. The initialization of the payment is triggered by the user pressing an icon that triggers a payment request directed at a selection application on the telephone 200. The payment is then of course finalized at the end of step 740 without the user performing an action.

The payment operation is therefore relatively simple for the user while a certain level of security during the operation is maintained. As indicated above, the security is in particular due to the fact that at least the sensitive steps are carried out in a secure environment, such as a secure circuit 234. Alternatively, it is possible to use the SIM card as a secure circuit or to use a removable secure circuit which is, for example, integrated into an SD card. Assuming that the telephone itself can be considered to be sufficiently secure, the secure circuit is not essential to the invention being carried out.

A person skilled in the art will also realize that the description, which has been given in relation to a smart mobile telephone, can be applied to other similar electronic devices. Everything that is described can thus be readily replicated on a tablet, a connected watch or a more conventional personal computer.

In the present example, the biometric sensor is a fingerprint sensor. However, it is also possible to use voice biometrics, the biometric sensor becoming a microphone and it being possible to take the print by means of user voice recognition on the basis of pre-stored words, such as the common name of the payment means, each sequence corresponding to a voiceprint and a payment means.

As indicated above, the payment means may also be applied to a transport network. The generated cryptogram is mainly an authentication of the user. This cryptogram is used either to establish that the user has a valid subscription or to debit an account containing prepaid tickets. While a selection need not be made if a single transport means is possible, authentication and simultaneous selection of the transport means becomes interesting as soon as a plurality of transport applications are present on the same telephone.

Furthermore, the invention has been described in connection with a mobile telephone, but the invention can be applied to other electronic devices. As indicated, said device may be a tablet, a laptop computer, a smart watch or even a multi-application smart card. If the device is a smart card, it is intended to have a fingerprint sensor but not necessarily a viewing screen. In this case, it is intended for the user to memorize the print associated with the payment means or for the card to display the equivalent of FIG. 6 on the payment terminal.

1. Method for payment by means of an electronic device (200) comprising:
at least one biometric sensor (220),
at least one communication interface (240, 250) for communicating with an external terminal (450) or remote terminal (400),
at least one processing unit (230) having banking information, biometric reference information, an authentication software program, one or more payment software programs, with the banking information and payment software programs providing the user with at least two payment means (610, 620, 630),
characterized in that the method allows a selection (510) of the payment means (610, 620,630) by associating each payment means with a biometric identifier (640, 650, 660) that is specific to said payment means, such that the biometric authentication makes it possible both to select the payment means and to generate a cryptogram for authorizing a transaction by means of said payment means.

2. Method according to claim 1, in which the selection of the payment means consists in making at least one of the following selections:
selecting, from among the banking information, information that corresponds to one of at least two bank cards,
selecting, from among the banking information, information that corresponds to one of at least two bank accounts,
selecting a different payment type from among at least two payment types,
selecting one of at least two software programs.

3. Method according to claim 1, in which the biometric identifiers are fingerprints and in which one fingerprint can only be used for one payment means.

4. Method according to claim 1, in which, prior to the selection of the payment means, a payment request is received by the electronic device together with an amount to be paid and in which device the amount to be paid is indicated on the display device along with a selection and authentication request.

5. Method according to claims 3 and 4, in which the fingerprint to be presented for each payment means is indicated on the display device.

6. Electronic device (200) comprising:
at least one biometric sensor (220),
at least one communication interface (240, 250) for communicating with an external terminal (450) or remote terminal (400),
at least one processing unit (230) having banking information, biometric reference information, an authentication software program, one or more payment software programs, with the banking information and the payment software programs providing the user with at least two payment means (610, 620, 630),
characterized in that each payment means (610, 620, 630) is associated with a biometric identifier (640, 650, 660) that is specific to said payment means, and in that the authentication software program allows a selection of the payment means at the same time (510) as the biometric authentication by associating the payment means with the presented biometric print after being authenticated.

7. Electronic device according to claim 6, wherein the communication interface is a radio interface (250) that is compatible with a contactless payment terminal.

8. Electronic device according to claim 6, wherein the communication interface is an internet interface (240).

9. Device according to claim 6, wherein the biometric sensor (220) is a fingerprint sensor and each fingerprint is associated with a payment means.

10. Device according to claim 6, wherein the processing unit comprises a secure processing circuit (233, 234) that is resistant to attacks and wherein at least part of the authentication and the generation of a transaction authorization cryptogram is carried out in said secure processing circuit.

11. Device according to claim 6, which further comprises a display device for displaying a transaction amount and a choice of payment means.
